(19) United States
(12) Patent Application Publication
(10) Pub. No.: US 2003/0149666 A1
(43) Pub. Date: Aug. 7, 2003

(54) Personal authentication system

(76) Inventor: Philip Michael Davies, Hants (GB)

Correspondence Address: MORGAN & FINNEGAN, L.L.P., 345 PARK AVENUE, NEW YORK, NY, 10154, US

(21) Appl. No.: 10/182,497

(22) PCT Filed: Nov. 7, 2001
(86) PCT No.: PCT/GB01/04930

(30) Foreign Application Priority Data
Nov. 20, 2000 (GB) 0028278.0

(51) Int. Cl. G06F 17/60

(52) U.S. Cl. 705/50

(57) ABSTRACT

A device authentication system, for example for consumer electronic products, uses a portable authenticator or key fob (16) to respond to periodic broadcast challenges from protected devices (10,12). Public key cryptosystem technology is used, with the owner's public key being stored within each of the protected devices, and the corresponding private key within the key fob. Each challenge issued by a protected device is encrypted using the public key, and on receipt decrypted using the private key. If decryption is successful, a verification message is sent from the key fob to the protected device, authorising the protected device to continue operation. If a verification message is not received by the device, the device ceases to operate.

The present invention relates to a personal authentication system. More specifically, although not exclusively, it relates to a method and apparatus for wireless authentication of consumer devices such as computers, cameras and the like.

Numerous schemes have been devised to protect high-value consumer products from theft. These range from simple password protection arrangements, where the user has to type in a password or security ID prior to use, to more sophisticated approaches involving automated product authentication. In WO-A-9804967, for example, a system is described for authenticating electronic products and components within a computer. Each component to be protected includes an embedded electronic immobilisation protection device (IPD) which periodically sends a cryptographically-secure “challenge”, across a computer network, to a central security service provider (SSP). In order for the component to operate, the SSP must reply with a valid response within a fixed time limit. If the component or the computer in which it resides has been reported stolen by the user, the SSP sends back an invalid response, which renders the component inoperative.

Although such a system is workable, it is extremely cumbersome, relying as it does on the product being protected having an always-available channel of communication (via a computer network) with the central SSP. If the network is down, or if the SSP is temporarily not available, the product becomes unprotected. Because the system relies on the presence of the network, it cannot be used to protect non-networked devices such as telephones, cameras, hi-fi systems and non-internet enabled computers. In addition, the need to have a trusted third party as an SSP increases the cost and complexity of the system as well as potentially reducing its security by the need to maintain a single ownership database which would no doubt be extremely valuable were it to fall into criminal hands.

It is an object of the present invention at least to alleviate these difficulties of the prior art.

It is a further object of the present invention to provide an easy to operate and relatively inexpensive system for authenticating products (especially consumer products) to an individual owner.

According to the present invention there is provided a device authentication system comprising an authenticator in bi-directional communication with at least one protected device, the authenticator including memory means for storing an electronic key identifying a key owner, a receiver for receiving a challenge from a protected device, a challenge validator for checking whether the challenge is valid for the said key owner and a transmitter for transmitting to the device a verification message if so; the protected device including memory means for storing an electronic lock indicative of a valid key owner for the device, a transmitter for transmitting a challenge indicative of the valid key owner for the device, a receiver for receiving the verification message, and a device control which controls operation of the device in dependence upon receipt or otherwise of the verification message.

According to a further aspect of the invention there is provided a method of device authentication comprising storing at the device an electronic lock indicative of a valid key owner for the device, issuing a challenge indicative of the valid key owner for the device, receiving the challenge at a site remote from the device, checking whether the challenge is valid for the said key owner by reference to a stored electronic key identifying the key owner, sending back a verification message if the challenge is valid, receiving the verification message at the protected device and controlling the protected device in dependence upon receipt or otherwise of the verification message.

In the preferred embodiments, it should not be possible to determine or to recreate the electronic key from any of the devices involved, or from any of the transmitted messages. This may conveniently be achieved by encrypting the messages according to a suitable public key cryptosystem in such a way that the electronic key within the authenticator is represented by the cryptosystem private key, while the lock within the protected device is represented by the corresponding public key. Any suitable public key cryptosystem could be used, for example the NTRU system described in PCT patent application WO-A-98/08323. Alternatively, the well-known RSA or PGP systems could be used.

Preferably, the authenticator is in bi-directional broadcast communication with the protected device or devices, for example using a radio, infra-red or ultrasound link. A direct electrical contact could also be used, and might be the preferred choice in some circumstances—e.g. the protection of automobiles. The authenticator preferably maintains details of the owner (for example the owner's private key) and merely responds to challenges by providing confirmation that the owner (or at least his authenticator) is nearby. The authenticator preferably knows nothing about the protected devices, and does not store details of them. Instead, information on who owns each protected device is preferably stored within the device itself, for example by means of the owner's public key.

Transfer of ownership, in the preferred embodiment, comprises changing the lock on the device being transferred so that it becomes associated with the electronic key of the new owner in place of the electronic key of the old owner. That may conveniently be achieved by replacing the public key of the old owner in the device's memory with the public key of the new owner.

Operation of the device is controlled automatically in dependence upon receipt or otherwise of the verification message. If a verification message is not received, the device may for example refuse to function at all, or it may alternatively function in a restricted mode. In some embodiments, the device may be programmed to operate differently according to the particular owner from which the verification message has come. Where the lock on the device is associated with several different owners, any of them may send a valid verification message, but some owners may have access to different features of the device from others.

According to a further aspect of the invention there is provided a method of device authentication comprising storing at the device an electronic lock indicative of a valid key owner for the device, issuing a challenge indicative of the valid key owner for the device, receiving the challenge at a site remote from the device, checking whether the challenge is valid for the said key owner by reference to a stored electronic key identifying the key owner, sending back a verification message if the challenge is valid, receiving the verification message at the protected device and controlling the protected device in dependence upon receipt or otherwise of the verification message.

According to a further aspect of the invention there is provided a method of device authentication comprising transmitting a challenge from a protected device to an authenticator, the challenge being encrypted by a cryptosystem public key, verifying the challenge at the authenticator by decrypting the challenge using the corresponding cryptosystem private key, transmitting a verification message back to the protected device if validation is satisfactory, and controlling operation of the device in dependence upon receipt or otherwise of the verification message.

According to a further aspect of the invention there is provided a device authentication system comprising at lease one product to be protected within which is stored a public key of a public key cryptosystem identifying the product owner, and or authenticator remote from the device within which is stored the corresponding private key.

According to a further aspect of the invention there is provided an electronic device for protection by a device authentication system, the device including a memory for storage of a public key of a public key cryptosystem, a transmitter for transmitting authentication challenges based on the public key, and a receiver for receiving responses to the challenges.

According to a further aspect of the invention there is provided an authenticator for authenticating challenges received from a device to be protected, the authenticator including a memory for storage of a private key of a public key cryptosystem, a receiver for receiving challenges, and a transmitter for transmitting verification messages based on the private key.

The present invention in its various embodiments provides numerous advantages;

Conventional keys and/or PINs are no longer required for protected devices. For example, an authenticator of the present invention could replace car ignition keys.

The transportation and storage chain from the product manufacturer to the retailer is protected.

Application —specific protection layers —can be set up by equipment owner or owners, allowing different access levels for individual users.

Protected consumer and household items may be visibly branded with an appropriate code, so as to discourage theft.

User intervention is minimal, and normal operation of the system is entirely user-transparent. Where a protected device is programmed to respond to several users, the device may automatically turn on or switch to the appropriate mode or level for the person who is using it, without the user needing to “log on” in the conventional sense.

Since knowledge of the device owners resides within the devices themselves, rather than centrally, there is no need for any central ownership database, nor the expense and potential security considerations involved in maintaining such a database.

Even if the authenticator/key fob is lost by its owner, an identical one can be generated easily from the secret pass-phrase known only to the owner.

In order to change the locks on all protected devices, all the user needs to do is to create or recreate (if lost) a key fob which includes both the new key and the old. The locks may be changed automatically by the system without further user intervention as an when each protected device issues its next challenge. Cycling the mains power, then switching each device on (from standby) could initiate this.

The invention may be carried into practice in a number of ways and one specific embodiment will now be described, by way of example, with reference to the accompanying drawings, in which:

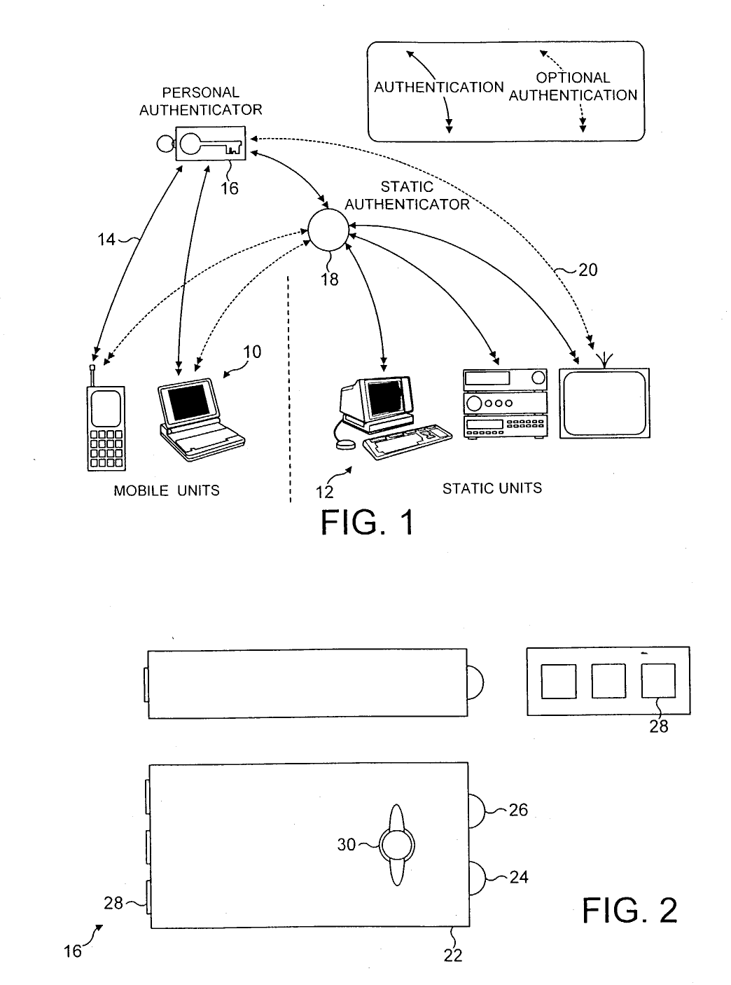

FIG. 1 shows an overview of the preferred system of the present invention;

FIG. 2 shows the physical key;

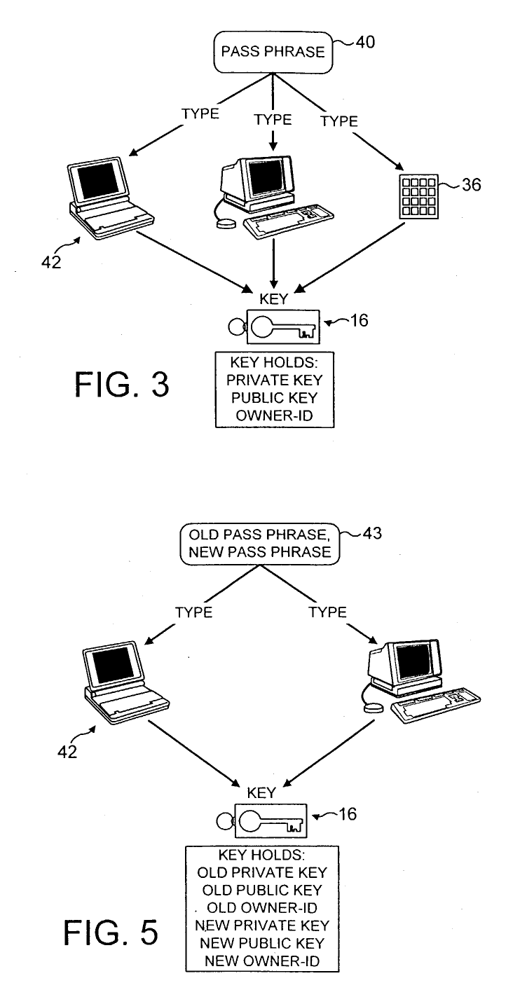

FIG. 3 shows the usual method of programming the key;

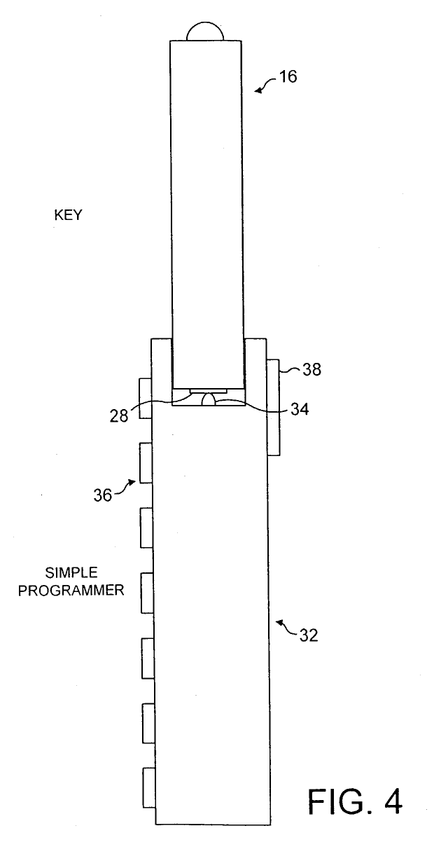

FIG. 4 shows the key programmer;

FIG. 5 shows the method of changing locks;

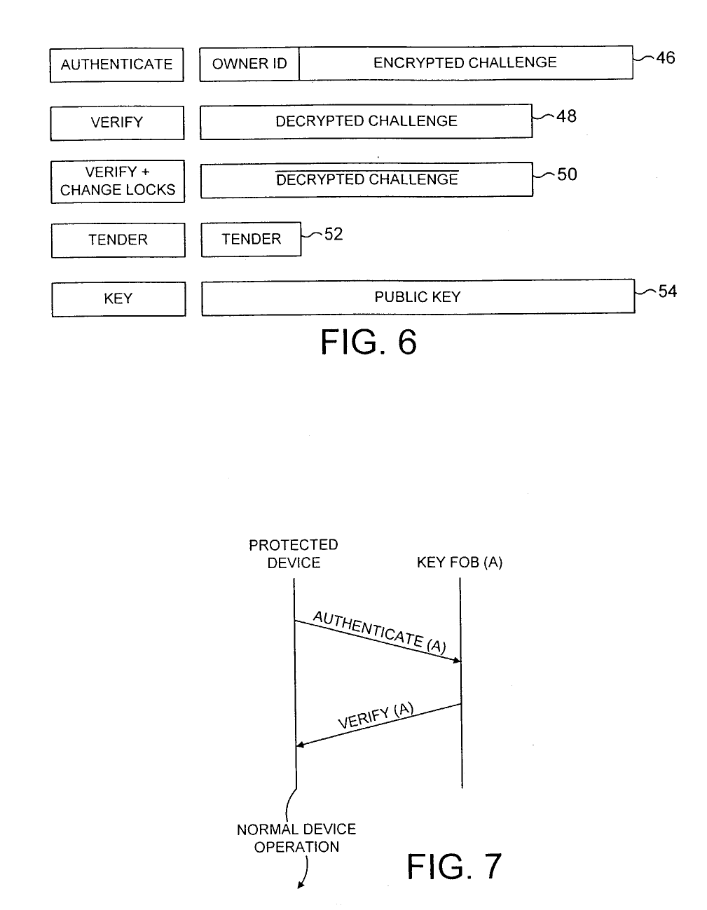

FIG. 6 shows the message contents,

FIG. 7 shows the message flows for normal successful authentication;

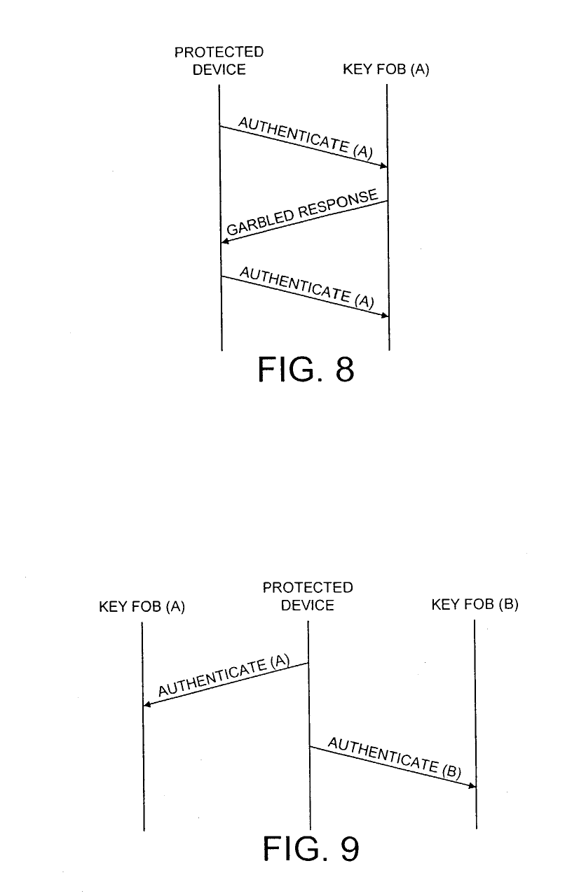

FIG. 8 shows the message flows for retry on garbled response;

FIG. 9 shows the message flows for retry on no response;

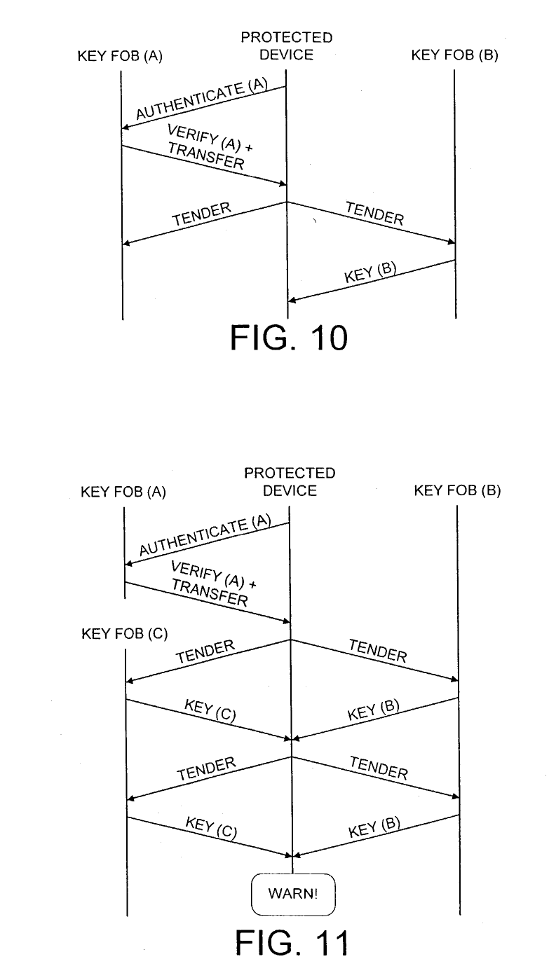

FIG. 10 shows the message flows for normal transfer of ownership;

FIG. 11 shows the message flows for transfer of ownership with contention;

FIG. 12 shows the message flows for transfer of ownership with no takers; and

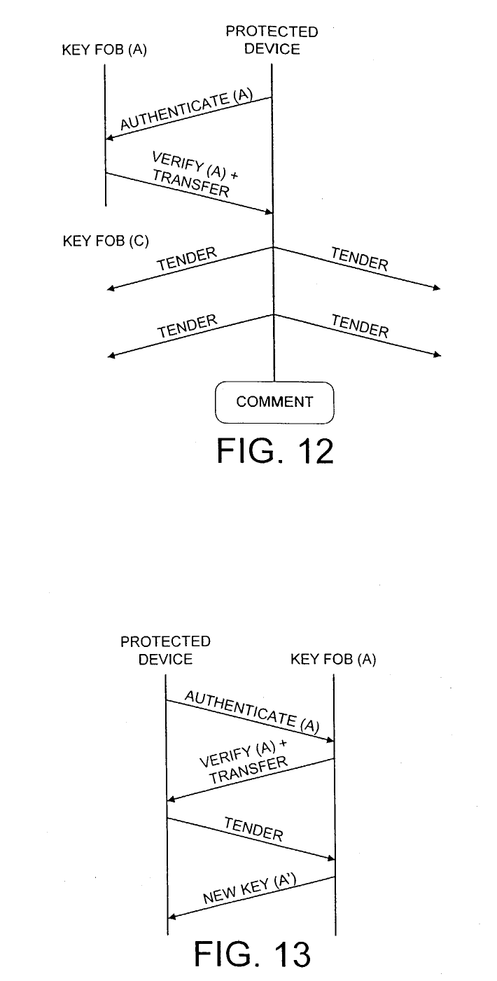

FIG. 13 shows the message flows for changing locks.

In the preferred embodiment, illustrated schematically in FIG. 1, the system is used to protect domestic consumer units against unauthorised operation. It will be understood, of course, that while the preferred embodiment relates to the protection of domestic consumer products such as mobile telephones, computers, televisions, hi-fi systems, cars and so on, other embodiments (not shown) could protect non-consumer units, devices or apparatus from unauthorised operation.

The system is based on providing an electronic lock within each protected device or consumer unit and a corresponding electronic key within one or more nearby authentication modules. Each protected device issues an electronic “challenge” (for example when the mains power is turned on), and waits for a response from an authentication module having the corresponding key. If no response is received, or if the response is invalid, the device will not function.

As shown in FIG. 1, the system may protect mobile units 10 (such as mobile telephones, portable computers, vehicles, cameras and the like), and static units 12 (such as fixed computers, hi-fi systems, televisions and the like). On power-on, each mobile unit 10 issues an electronic challenge 14, which will normally be answered automatically by a personal authenticator (key fob) 16 carried on the owner's person. Challenges issued by static units 12 may be answered by a static authenticator 18, which may for example be a small module plugged into a mains power socket somewhere in the user's house where it will not be easily visible or accessible to a potential burglar. And in any case, a static authenticator would store its keys in volatile memory, so power interruptions would erase the keys. A static authenticator could also delete its keys for other reasons (e.g. movement of the unit).

Depending upon the application, the key fob 16 may also be used to authenticate static units 12 while the static authenticator 18 may be used to authenticate mobile units 10. This is illustrated by the dotted lines 20.

Communication between the authenticators and the devices to be protected may be via any convenient communications medium. The communications medium is of course independent of the communications protocol to be used, and simply needs to provide a bi-directional link with a broadcast capability. In some embodiments, infra-red communication (for example IrDA) may be used. This is convenient where the devices need to communicate locally over short distances. The power requirements are small, especially for low-duty use, and the cost is also very low. The restriction of course is that infra-red technology normally requires line of sight communication. This might be acceptable in a car, or within the living room of a house, where a fixed authenticator might “see” all of the devices as they are switched on. Other possibilities include ultrasound communication and radio communication, for example using “Bluetooth” technology.

The authenticators may allow for dual or multiple communications across different media, thereby allowing device manufacturers flexibility as to their own preferred mode of communication. In such a case, a transponder within the authenticator would send its authentication signal back across the same transport medium by which the challenge was originally received.

The communications protocol is preferably based on a public key cryptosystem, with the private keys being held within the authenticators. Each device to be protected holds the corresponding public key, and issues its challenges encrypted by that key. Using its private key, the authenticator can decrypt the challenge and —if valid —send back an appropriate authorisation to the broadcasting device. This will be described in more detail below.

In order to create a private/public key pair a “pass phrase” is needed. This is known only to the key fob owner, and needs to be kept confidential. The key fob may also contain a unique owner ID and/or additional data identifying the actual owner. This could either be stored separately, or could be encrypted and/or incorporated as part of the key. The owner ID could alternatively be generated automatically from the public key (eg by means of a hash function).

In normal operation, the device periodically requests authentication by encoding some information unique to the product such as its unique product ID or a randomly-generated string to the public key, and broadcasting that as a challenge. The use of a unique product ID would be insecure (and hence is not preferred) since the response would always be the same and could thus be snooped. On receipt, the key fob decrypts the challenge using its private key and checks for validity. If the product issuing the challenge is one that is allowed to authenticate (that is, it is a product that is broadcasting using a public key which is known to the key fob), it broadcasts back an authentication message. That may take any convenient form, but since it has to be unique to the product which issued the challenge in the first place, it will typically take the form simply of the decrypted challenge. On receipt of the decrypted challenge, the device will then operate normally.

In the same way that a physical key fob allows the fob holder to unlock physical devices, in this system the private keys within the authenticator allow the user automatically to unlock electronic devices. The private keys within the authenticator correspond to physical keys, and the public keys within the devices to be protected correspond to physical locks.

The key fob is not aware of the individual products being protected, only the identify of one or more owners. The devices being protected know who owns them: ie store information which ensures that only the key fob of a valid device owner can legitimately authenticate itself to that device. In the same way that physical possession of both a car and its keys will allow the car to be driven, physical possession of both the authenticator and the corresponding device will allow the device to be operated. Accordingly, the device owner needs to take as much care with the authenticator as with a physical bunch of keys.

Each device to be protected broadcasts its challenges automatically, as necessary. Challenges could be issued periodically, at regular intervals, but that may not be desirable, particularly with portable devices, because of the power drain on both the device itself and on the key fob. Alternatively or in addition, the device may issue a challenge at one or more predefined points, for example when the main power is first turned on, or when the user attempts to access a specific feature within the product. Different product manufacturers may wish to pre-program their devices to issue challenges at different times. It may be convenient, for example, for a lap-top computer to issue a challenge when it is first switched on, whereas a car manufacturer may prefer to have a challenge issued both when the remote door unlocking is actuated and also when the ignition is switched on. Rental companies may provide devices that periodically issue challenges, for example once a day, and which “time out” once the rental period has expired. Rented televisions or video recorders could in that way automatically become unusable if they have been retained by the user after the end of the agreed rental period.

Each device may have a number of owners: that is, it may accept authentication from a number of different keys held by different people. For example, a television set could be programmed to accept authentication from either the husband's key or the wife's key. Provision may be made for the device manufacturer to operate differently according to the authenticating key, so that for example if a child's key is used to provide authentication the television will not permit access to certain prohibited channels.

When the user is at home or otherwise near a static (mains-powered) authenticator 18, his or her key fob 16 may be programmed not to respond immediately to a received challenge but instead to wait a short period for the static authenticator to respond instead. That conserves the batteries within the key fob. In the event that the static authenticator does not respond within a predefined period, the key fob 16 provides the necessary authentication to the device that issued the challenge. Similarly, two or more key fobs 16 may work together so that one takes precedence over the other for certain devices. For example, if the device issuing the challenge is the wife's car, the husband's authenticator will wait for the wife's response first and will step in with its own authentication only if the wife's does not reply.

Turning now to FIG. 2, there is shown schematically the physical form of the personal authenticator 16. The authenticator takes the form of a “key fob” or “electronic key-ring”. For convenience, the unit could, if desired, include a key-ring attachment (not shown) so that the user may keep his or her physical and electronic keys together. The preferred key fob is similar in appearance to a car alarm key fob.

The device comprises a plastics housing 22 containing within it a CPU (not shown) having inaccessible non-volatile memory, a transmitter 24, a receiver 26 and contact pads 28 for private key download, secure transfer and optional charging. Finally, the unit includes a recessed button 70 which is used as described in more detail below to transfer ownership. In operation, the CPU runs personal authentication software which provides the functionality previously described and described in more detail below with reference to FIGS. 5 to 13.

The authentication unit may further include (if desired but not shown) display means and/or data input means to allow it to be programmed. Preferably, however, the authenticator is kept small and simple, and programming is achieved by plugging it into a separate key programmer, shown schematically in FIG. 4. As shown in that Figure, when the authenticator needs to be programmed it is slotted in to one end of a key programmer unit 32, so that the contact pads 28 make electrical contact with corresponding contact pads 34 on the programmer. All key changes are preferably carried out using a direct connection of this type to avoid the inherent insecurity of a wireless connection. The programmer itself includes a keypad 36 or similar input means, and optionally a display 38.

In order to program a new key fob or to generate new private/public key pair for an existing fob, the fob is first inserted into the programmer as shown in FIG. 4. As illustrated in FIG. 3, the user then types in a private pass phrase 40 either directly on the keypad 36 or on a keyboard of a separate computer 42 which is itself coupled to the programmer. The CPU of either the separate computer 42 or that within the key fob 16 then generates the private/public key pair in the usual way, and both keys are stored in the non-volatile memory of the fob 16. In addition, a unique owner ID may also be provided and stored, and/or additional details of the owner such as name and address. Those details are preferably encrypted or are themselves combined with the pass phrase to create the key pair. Alternatively, the owner ID may be generated automatically from the public key.

Once the key fob has been programmed, the keys within it will not normally be changed unless the owner suspects that they may have been compromised.

In order for the system to recognise a new product, for example one that has just been purchased, the lock on the product has to be set to accept the owner's key. That will normally be done simply by powering-up the product causing it to generate an initial challenge. That may either be unencrypted or may be encrypted to a default key. On receipt of the default challenge, the key fob recognises that a new lock has to be set up, and responds accordingly, sending back to the device details of the new user's public key, to be used for the future. The device then changes its lock to associate itself with the public key.

As an alternative to issuing a default challenge, a new product may, during manufacture or during subsequent testing, be provided with its own individual lock, generated by the manufacturer from an individual pass phrase. Provided that the pass phrase is transmitted to the retailer separately from the product (for example by post or e-mail), the product will remain secure during shipping. At the point of sale, the retailer (who will hold a large number of blank key fobs) programs the new key fob for the customer using the pass phrase for that particular product, and hands over the product, the key fob and the pass phrase once the purchase is complete. The new owner will at a later stage probably wish to change the lock on the product to match a key which already exists on his or her own personal key fob.

Alternatively, if it is possible to power-up the product in the shop, the product's lock may be changed there and then to match the private key of the owner.

Another possibility would be just to add the default private key of the product to the user's key fob (if necessary creating the key pair using the default pass phrase for the product, as supplied by the manufacturer).

The programmer 32 allows the user to perform the following actions: clear a key fob of all its contents; list the dates of the keys within the key fob; delete a key from the key fob; add a new key to the key fob; and link a key to another as its replacement. It is not possible to use the key programmer to extract a key from the key fob, and the pass phrase is not stored on the fob anyway.

The application programmer for the device has library function calls:

void startup ( )
{

if flash memory is zeroed {first time power applied)

while not tender ( )

wait ( ) ;

endwhile

endif
authenticate_users ( ) ;

}
void authenticate_users ( )
{

int num_users = get num_users ( ) ;
int user = 0;
loop

if authenticate (public_key [user])

break;

user = (user + 1) mod num_users;

endloop

}
pubkey add_new_user(pubkey old_user) {forces an authenticate on
old user followed by a tender for an additional user}
boolean authenticate (pubkey public_key)
challenge create_challenge ( )
challenge encrypt_challenge (challenge challenge)
void send_challenge (challenge encrypted_challenge)
message get_response ( )
challenge response_to_challenge (message msg)
etc.

If the user suspects that the key has been compromised, the procedure shown in FIG. 5 is used to change both the key and the locks on the individual products. With the key fob plugged into the programmer as shown in FIG. 4, the user enters the old pass phrase followed by the new pass phrase 43 either into the keypad 36 of the programmer or via a linked computer 44. The system generates a new key pad based on the new pass phrase, and that information is held within the key fob 16 along with the existing information. Additional ownership information and/or a new owner ID may be provided, if necessary, or alternatively the new owner ID may be generated automatically from the public key.

The key fob retains the information about both the old and the new keys, and uses that information automatically to change the lock of any product which issues a challenge using the old private key. Specifically, the key fob first checks the validity of the challenge using the old key, and provides the requested authentication. At the same time, it automatically sends a further signal to the device instructing it for the future to use the new public key.

The recessed ownership transfer button 30 (FIG. 2) on the key fob allows for the automatic changing of locks when a product is being transferred from one owner to another (for example by means of a private sale). When transferring ownership of a product, the current owner and the intended recipient each hold down the button 30 on their respective key fobs. The product being transferred is then power-cycled or otherwise forced to issue a challenge. This causes the product's lock to be changed automatically from the current owner to the intended recipient. That will be described in more detail below.

FIG. 6 illustrates the contents of the messages that are exchanged across the air between the key fob and the product requesting authentication. These will be referred to below in the discussions of FIGS. 7 to 13.

The “authenticate” message consists of the owner ID (which may be a hash of the public key, perhaps 32 bits long) followed by a challenge, encrypted to the public key of the owner (this being stored within the non-volatile memory of the product requesting authentication). The challenge itself may simply be a random stream of data. Since the challenge will be different for each product, each time, by keeping a record of what was encrypted the product can identify the correct response when it arrives. A further advantage of using random (or at least randomised) data is that both the message and the response will be different every time, thereby preventing electronic “snooping”.

The “verify message” 48 preferably consists simply of the challenge, decrypted using the appropriate private key within the user's key fob. It will be understood of course that other types of message could be used, the only requirement being that the message can be identified as being unique to the product that issued the challenge: a correct decryption will always indicate this.

The “verify and change locks message” 50 consists in this embodiment of the logical NOT of the decrypted challenge. That is a convenient approach, since taking the logical NOT of the message is a very simple and quick operation, and does not change the message length. In addition, it is a hidden way of requesting a lock change, since both the response and its logical NOT will be indistinguishable from random data. This makes change-of-ownership attacks harder. Further, it is more robust because a single bit could change with noise, the authentication might succeed (because that part was not corrupt) and it could therefore try to accept a new lock when only ordinary authentication was wanted. With the NOT solution, any changed bit would fail authentication and would necessitate retries.

Once again, of course, alternative messages could easily be devised; all that is required is some way of telling the product that its lock needs to be changed, and that in future it should be encrypting to a new public key.

The “tender message” 52 is a simple token, used as below during transfer of ownership.

The “key” 54 is the current binary public key.

The way on which these messages are used will now be described with reference to FIGS. 7 to 13.

FIGS. 7 illustrates normal successful authentication. When programmed or otherwise triggered to do so, (for example on power-up) the protected device broadcasts an authenticate message which is received by a nearby key fob. Assuming that the message decrypts correctly using one of the private keys contained within that key fob, the key fob then replies by broadcasting a verify message. Indeed, the fob need not know (or care) whether the decryption was successful or not: it has simply been asked to prove its identity, and it has sent out a message doing so. It is up to the recipient to check whether the verify message is valid. If the challenge comprises random data, the fob will of course have no way of knowing whether the decryption has produced a valid response that will be accepted as such by the sender. On receipt of that message, the device continues to operate normally. If the verify message is not received, the device may cease normal operation, switch to a limited-use mode or alternatively switch itself off.

FIG. 8 shows what happens when the protected device receives a garbled response. This could happen if there is a break or noise on the channel. As may be seen, the device automatically retries by broadcasting a further authenticate message (preferably different from the first one, based upon a new random stream of data). The device may be programmed to send out repeated authenticate messages for a fixed number of tries before giving up.

FIG. 9 illustrates the message flows when a protected device is owned by two separate individuals, each having their own key fobs and private keys. For example, as mentioned above, a car could be “owned” by both husband and wife, with the wife's key fob (A) taking precedence over the husband's key fob (B). In such a situation, the car will be programmed to send out a first authenticate message coded to A and then, if no answer is forthcoming, a second message this time coded to B. Devices may also be set up to require all members of a certain group to be present before continuing.

FIG. 10 illustrates the message flows during normal transfer of ownership of a protected device from a key held within a first key fob (A) to a key held within a second key fob (B). It will be noted that the message protocols are different from those during normal operation (FIG. 7). The change in mode is effected by the key fob owners pressing and holding down the ownership transfer button 30 (FIG. 2).

The protected device, which is initially using a public key associated with A, broadcasts an authenticate message to a key fob A which replies with a “verify and change locks” message. On receipt of that message, the device understands that ownership is being transferred, and it broadcasts a general tender message. Key fob A knows that ownership is being transferred away from it, and hence does not reply to the tender. Key fob B on the other hand, replies with its public key, which then replaces the public key of A within the device memory. For the future, the device will then encrypt challenges to the public key of B.

FIG. 11 illustrates what happens when there is contention over transfer of ownership. As before, the protected device issues an authenticate message encrypted to A and key fob A responds with a “verify and change locks” message. The device then issues a general tender. In this case, however, two separate keys B and C both purport to accept the tender. The device waits for a short period, reissues the tenders and, if there is still contention, warns the user (for example by means of a bleep) that transfer is impossible.

FIG. 12 shows what happens if ownership is to be transferred, but there are no takers. In such a case, the protected device will issue tender requests several times and, if no response is forthcoming, will (for example by means of a bleep) issue a comment or warning to the effect that there are no takers.

FIG. 13 illustrates how a lock may be changed on a protected device. This may be necessary when a key has been lost, changed, or is otherwise suspected to be compromised. In the example shown, the key fob A contains an old public key A and a new public key A′. The protected device initially uses A to issue challenges. Since the key fob is aware that all devices currently using A need to have their locks changed to A′, it automatically responds to an authenticate message to A in ownership transfer mode, even though the ownership transfer button is not depressed. Thus, on receipt of the authenticate to A message, the key fob replies with a “verify and change locks” message. The device then issues a tender, to which the key fob replies with the new public key A′. This replaces the old public key A within the protected device's memory.

For additional security, the system may incorporate a number of additional features. For example, each key fob may be programmed to require periodic authentication from its owner, thereby making the key fob useless if it were to be lost. This authentication could take the form of periodic reprogramming of the unit, either at fixed intervals or after certain events. For example, the key fob may periodically need to be plugged into a programmer and to be revalidated with the pass phrase, a personal identification number or some other information known only to the owner. Alternatively, thumb print, voice or other personal authentication may be used.

Where a product has a manufacturer's unique identification number, that number could optionally be used to reset ownership in the event that a pass phrase is forgotten. After making appropriate security checks, the manufacturer or retailer would supply the owner with an appropriate unlocking code which will allow the product to re-register with a new public key.

The micro-controller or other CPU, which operates the device under protection (or its associated non-volatile memory), will usually contain the software required for authentication, and possibly the internal or associated flash memory. Removing this requires the replacement of one or more significantly complex and relatively expensive surface mount devices. These also have an extremely high count of very small pins, making their replacement impractical.

1. A device authentication system comprising an authenticator in bi-directional communication with at least one protected device, the authenticator including memory means for storing an electronic key identifying a key owner, a receiver for receiving a challenge from a protected device, a challenge validator for checking whether the challenge is valid for the said key owner and a transmitter for transmitting to the device a verification message if so; the protected device including memory means for storing an electronic lock indicative of a valid key owner for the device, a transmitter for transmitting a challenge indicative of the valid key owner for the device, a receiver for receiving the verification message, and a device control which controls operation of the device in dependence upon receipt or otherwise of the verification message.

2. A device authentication system as claimed in claim 1 in which the electronic key is represented by the private key of a public key cryptosystem, and the lock is represented by the corresponding public key.

3. A device authentication system as claimed in claim 1 or claim 2 in which the authenticator is static and draws mains power.

4. A device authentication system as claimed in claim 1 or claim 2 in which the authenticator is portable and is carried by the key owner.

5. A device authentication system as claimed in any one of the preceding claims, in which the authenticator is in broadcast communication with the protected device.

6. A device authentication system as claimed in claim 5 in which the authenticator is in communication with the protected device via a wireless link.

7. A device authentication system as claimed in claim 6 in which the wireless link is an infra-red link.

8. A device authentication system as claimed in claim 6 in which the wireless link is an ultra-sound link.

9. A device authentication system as claimed in claim 6 in which the wireless link is a radio link.

10. A device authentication system as claimed in any one of claims 1 to 9 in which the authenticator is capable of communicating with multiple protected devices over a plurality of different communications media.

11. A device authentication system as claimed in any one of claims 1 to 10 in which the lock is indicative of a plurality of valid key owners.

12. A device authentication system as claimed in any one of claims 1 to 11 in which the electronic key is representative of a plurality of individual key owners.

13. A device authentication system as claimed in any one of claims 1 to 12 in which the challenge is indicative of both a valid key owner for the device, and of the device itself.

14. A device authentication system as claimed in claim 13 when dependent upon claim 2 in which the challenge comprises data, including a product ID, which is encrypted to the public key.

15. A device authentication system as claimed in claim 13 when dependent upon claim 2 in which the challenge includes random data which is encrypted to the public key.

16. A device authentication system as claimed in any one of claims 1 to 15 when dependent upon claim 2 in which the verification message includes the challenge encrypted using the private key.

17. A device authentication system as claimed in any one of claims 1 to 16 in which the challenge and the verification message differ for each exchange between the authenticator and the protected device.

18. A device authentication system as claimed in any one of claims 1 to 17 including a plurality of authenticators each storing the same electronic key, at lease one authenticator being arranged to send a verification key only after a delay, to allow another authenticator to respond first.

19. A device authentication system as claimed in any one of claims 1 to 18 including a plurality of authenticators each storing the same electronic key, at least one authenticator, on receipt of a challenge, being arranged to listen for a period and to inhibit the sending of a verification message if another authenticator replies within that period.

20. A device authentication system as claimed in any one of claims 1 to 19 in which the authenticator includes an ownership transfer mode which, when engaged, causes the authenticator to transmit to the protected device a message indicative of a new lock, to be used by the protected device for future challenges.

21. A device authentication system as claimed in claim 20 in which the ownership transfer mode may be manually engaged by a user, for example by pressing a button.

22. A device authentication system as claimed in claim 20 in which the ownership transfer mode is engaged automatically by the authenticator when it is advised that the electronic key is being changed to a new key.

23. A device authentication system as claimed in any one of claims 20 to 22 in which the authenticator transmits the message indicative of the new lock to the protected device on receipt from the protected device of a tender message.

24. A device authentication system as claimed in claim 23 in which the tender message is sent by the protected device on receipt of a transfer message from an authenticator.

25. A device authentication system as claimed in any one of claims 20 to 24 including a programmer having input means for changing keys within an authenticator.

26. A device authentication system as claimed in claim 25 in which the authenticator is arranged for physical electrical connection to the programmer when the programmer is in use.

27. A device authentication system as claimed in any one of claims 20 to 26 in which the protected device issues a challenge on power-up.

28. A method of device authentication comprising storing at the device an electronic lock indicative of a valid key owner for the device, issuing a challenge indicative of the valid key owner for the device, receiving the challenge at a site remote from the device, checking whether the challenge is valid for the said key owner by reference to a stored electronic key identifying the key owner, sending back a verification message if the challenge is valid, receiving the verification message at the protected device and controlling the protected device in dependence upon receipt or otherwise of the verification message.

29. A method of device authentication comprising transmitting a challenge from a protected device to an authenticator, the challenge being encrypted by a cryptosystem public key, verifying the challenge at the authenticator by decrypting the challenge using the corresponding cryptosystem private key, transmitting a verification message back to the protected device if the validation is satisfactory, and controlling operation of the device in dependence upon receipt or otherwise of the verification message.

30. A device authentication system comprising at least one product to be protected within which is stored a public key of a public key cryptosystem identifying the product owner, and an authenticator remote from the device within which is stored the corresponding private key.

31. An electronic device for protection by a device authentication system, the device including a memory for storage of a public key of a public key cryptosystem, a transmitter for transmitting authentication challenges based on the public key, and a receiver for receiving responses to the challenges.

32. An authenticator for authenticating challenges received from a device to be protected, the authenticator including a memory for storage of a private key of a public key cryptosystem, a receiver for receiving challenges, and a transmitter for transmitting verification messages based on the private key.
